(19) United States
(12) Patent Application Publication
(10) Pub. No.: US 2003/0105813 A1
(43) Pub. Date: Jun. 5, 2003

(54) Information processing system and method, and server for use in the system

(76) Inventor: Yasunao Mizutani, La Jolla, CA (US)

Correspondence Address: ARMSTRONG,WESTERMAN & HATTORI, LLP, 1725 K STREET, NW, SUITE 1000, WASHINGTON, DC, 20006, US

(21) Appl. No.: 10/265,905

(22) Filed: Oct. 8, 2002

Related U.S. Application Data
(63) Continuation of application No. PCT/JP00/02302, filed on Apr. 10, 2000.

(51) Int. Cl. G06F 15/16

(52) U.S. Cl. 709/203

(57) ABSTRACT

A client sends input information of an external device to a server to make a demand for processing, and receives output information from the server to output to the external device. The client initializes the I/O unit based on initialization information received from the server. The server sends initialization information of the external device upon reception of a demand for connection from the client, and, in connection, processes input information received from the client to send output information to the client. The server manages connection with the client, and when communication with the client ceases on the server, interrupts processing of the application processing unit to hold the status at interruption and the output information to the client. when communication with the client resumes, the server resends the initialization information to the client for initialization and resumes the processing of the application processing unit and the sending of the output information.

### TECHNICAL FIELD

The present invention relates generally to an information processing system and method in which a client makes a request to a server for processing, and a server for use in the system, and more particularly to an information processing system and method capable of properly coping with any failures and power shutoff on the client side, and a server for use in the system.

### BACKGROUND ART

Hitherto known as an information processing system connecting a server and a client via a communication line is a system running an application program on the server, with the client transmitting input information via the communication line to the application program on the server, for processing, with the client receiving output information sent from the application program on the server, the system providing an output to an external I/O device through the connection to the client. Such an information processing system can be a POS system for example. In the POS system, a server is connected to a plurality of clients acting as POS terminals and the clients are each associated with external I/O devices such as a bar code reader, a display, a printer, etc. When receiving a commodity bar code read input from the bar code reader, the client transmits the bar code read information to the application program on the server to execute processing for sales. Output information obtained as a processing result is sent to the client, displayed on the display and simultaneously output from the printer. In cases where such an information processing system suffers power shutoff to the client and communication shutoff between the serve and the client, the processing is interrupted, resulting in a situation needing restart of the processing from the very beginning. To obviate this, the status of the application program and the output information to the client are held on the server such that upon the resumption of connection, the application program processing and the output information sending are resumed, to enable the processing to continue irrespective of the interruption.

In such an information, however, when a client makes a demand for connection on the server, the client may sent initialization information for the external I/O devices to the client so that the initialization processing is carried out. In the POS system for example, when the server receives a demand for connection from the POS terminal of the client, the server sends to the client the initialization information designating a read code of the bar code reader to effect the initialization processing of a bar code reader I/O driver (an I/O unit). However, in cases where the server sends the initialization information in response to the demand for connection, with the client having the I/O unit which needs certain initialization processing, if a communication failure occurs and the processing is interrupted as a result of the client power shutoff, the status of the client could not be restored to the status at interruption even though the power has been recovered, making it difficult to continue the processing.

### DISCLOSURE OF THE INVENTION

According to the present invention there are provided an information processing system, method, and server, capable of continuing the processing upon recovery or by substitution with another client in the event of power shutoff or failure of a client having an I/O unit which needs initialization processing based on initialization information from the server.

The present invention is directed to an information processing system in which a server and a client are connected to each other by way of a communication line, the client making a request to the server for processing, the client receiving the result of the processing from the server. In such an information processing system, the client comprises an I/O processing unit which sends input information of an external device to the server to make a demand for processing, the I/O processing unit receiving output information from the server to output to the external device; and an initialization unit which initializes the I/O unit based on initialization information received from the server. The server comprises an application processing unit which sends initialization information of the external device upon reception of a demand for connection from the client, the application processing unit, in connection, processing input information received from the client and sending output information to the client; and a session processing unit which manages connection with the client, the session processing unit when communication with the client ceases on the server, interrupting processing of the application processing unit to hold the status at interruption and the output information to the client, the session processing unit when communication with the client resumes, resending the initialization information to the client for initialization and resuming the processing of the application processing unit and the sending of the output information. According to such an information processing system of the present invention, when the client makes a demand for connection after power recovery even though the processing is interrupted due to power shutoff during the connection, initialization information is first sent to the client to perform the initialization required for the I/unit, to thereby restore the client to the status at the interruption, and then resume the interrupted processing, thus making the continuation possible.

The session management unit manages connection between the server and the client by session No., the session management unit after ceasing of communication with the client, resuming the communication when the session management unit receives a demand for connection from the client with the identical session No. The session management unit when receiving a demand for connection from another client after ceasing of communication with the client, resends initialization information to the another client and resumes the processing of the application processing unit and the sending of the output information, if the identity of the session No. is judged. For this reason, in the event of being incapable of waiting for the power recovery of the client which was used at the interruption or the recovery of the communication line, another client makes a demand for connection with the identical session No. (specifically, the same client ID) to thereby enable the processing to be continued. The session management unit upon reception of a demand for connection from the client refers to session management information using the client ID and, if there is no session No. with identical client ID, acquires a new session No. and enters it together with client ID and the status of the application processing unit into the session management information for processing. The session management unit if the client ID is identical, acquires a session No. with the identical client ID for processing. Such a demand for connection by the client ID enables the same processing as in the case where the session No. is designated by the client to be carried out. The client ID can be an account for use in login of the client, a name for use in logon, a network address or other unique identifiers. The session management unit verifies connection at certain time intervals in order to detect ceasing of communication with the client. By virtue of this, even when the client is out of connection, the client's power shutoff, failure and communication line failure can be detected and coped with.

The present invention allows the processing to be continued in response to the demand for connection with the identical session No. by another client even when the session with the session No. demanded for connection is not interrupted. To implement this information processing system, the server of the present invention comprises an application processing unit which sends initialization information of the external device upon reception of a demand for connection from the client, the application processing unit, in connection, processing input information received from the client and sending output information to the client; and a session processing unit which manages connection with the client by session No., the session processing unit in connection with the client when receiving a connection demand with the identical session No. from another client, connecting to the another client which has sent the connection demand to continue the processing, if cutoff of connection is judged through the verification of connection with the client in connection. In this case, the client comprises an initialization unit which initializes the I/O unit based on initialization information received from the server; and an I/O processing unit which sends input information of an external device to the server to make a demand for processing, the I/O processing unit receiving output information from the server to output to the external device. This configuration is the same as the system coping with the interruption of the session. Furthermore, the session management unit sends initialization information of an external device to the another client which has sent the connection demand, to thereby continue the processing, and the session management unit upon reception of a demand for connection from the client refers to session management information and, if there is no session No. with identical client ID, acquires a new session No. and enters it together with client ID and the status of the application processing unit into the session management information for processing, the session management unit if the client ID is identical, acquiring a session No. with the identical client ID for processing, which are also the same as in the system configured to cope with the interruption of session.

The present invention further provides an information processing method in which a server and a client are connected to each other by way of a communication line, the client making a request to the server for processing, the client receiving the result of the processing from the server; the method comprising the steps of:

when the server receives a demand for connection from the client, sending initialization information from the server to the client to initialize an external device I/O unit;

when the server and the client are in connection, processing input information of an external device received from the client, by an application program on the server, and sending output information to the client for output;

managing connection with the client on the server, and if communication with the client ceases on the server, interrupting the application program to hold the status at interruption and the output information to the client; and

at the time when communication with the client resumes, resending the initialization information to the client for initialization, and resuming the processing of the application program and the sending of the output information.

The present invention also provides an information processing method in which a server and a client are connected to each other by way of a communication line, the client making a request to the server for processing, the client receiving the result of the processing from the server; the method comprising the steps of:

when the server receives a demand for connection from the client, sending initialization information from the server to the client to initialize an external device I/O unit;

when the server and the client are in connection, processing input information of an external device received from the client, by an application program on the server, and sending output information to the client for output;

managing connection with the client by session No. on the server, and when receiving a connection demand with the identical session No. from another client while being in connection with the client, connecting to the another client which has sent the connection demand to continue the processing, if cutoff of connection is judged through the verification of connection with the client in connection.

The details of these information processing methods are substantially the same as the case of the apparatus configurations.

Further, the present invention provides a server connected via a communication line to a client. The server comprises an application processing unit which sends initialization information of an external device I/O unit upon reception of a demand for connection from the client, the application processing unit, in connection, processing input information received from the client and sending output information to the client; and a session processing unit which manages connection with the client by session No., the session processing unit when communication with the client ceases on the server, interrupting processing of the application processing unit to hold the status at interruption and the output information to the client, the session processing unit when communication with the client resumes as a result of a demand for connection with the identical session No., resending the initialization information to the client for initialization and resuming the processing of the application processing unit and the sending of the output information.

Further, the present invention provides a server connected via a communication line to a client, the server comprising an application processing unit which sends initialization information of an external device I/O unit upon reception of a demand for connection from the client, the application processing unit, in connection, processing input information received from the client and sending output information to the client; and a session processing unit which manages connection with the client by session No., the session processing unit in connection with the client when receiving a connection demand with the identical session No. from another client, connecting to the another client which has sent the connection demand to continue the processing, if disconnection is judged through the verification of connection with the client in connection.

### BRIEF DESCRIPTION OF DRAWINGS

FIG. 1 is a block diagram of a system configuration in accordance with the present invention;

FIG. 2 is an explanatory diagram of a session management table provided in a server of FIG. 1;

FIGS. 3A to 3F are explanatory diagrams of control commands for use in initialization of an I/O unit for a bar code reader of FIG. 1;

FIGS. 4A to 4C are explanatory diagrams of formats for use in transmission of information read by the bar code reader;

FIGS. 5A and 5B are timing charts of processing operations effected when the client sends a demand for connection and input information to the server;

FIGS. 6A and 6B, continuations of FIGS. 5A and 5B, are timing charts of processing operations effected when the client suffers power shutoff and restores it to resume the processing;

FIGS. 7A and 7B are timing charts of processing operations effected when the client sends a demand for connection and input information to the server;

FIGS. 8A and 8B, continuations of FIGS. 7a and 7B, are timing charts of processing operations effected when the client breaks in use, with another client making a demand for connection to resume the processing;

FIGS. 9A and 9B are flowcharts of processing operations effected by the server of FIG. 1;

FIG. 10 is a flowchart of communication verification processing effected by the server of FIG. 1; and

FIGS. 11A and 11B are flowcharts of processing operations effected by the client of FIG. 1.

### BEST MODE FOR CARRYING OUT THE INVENTION

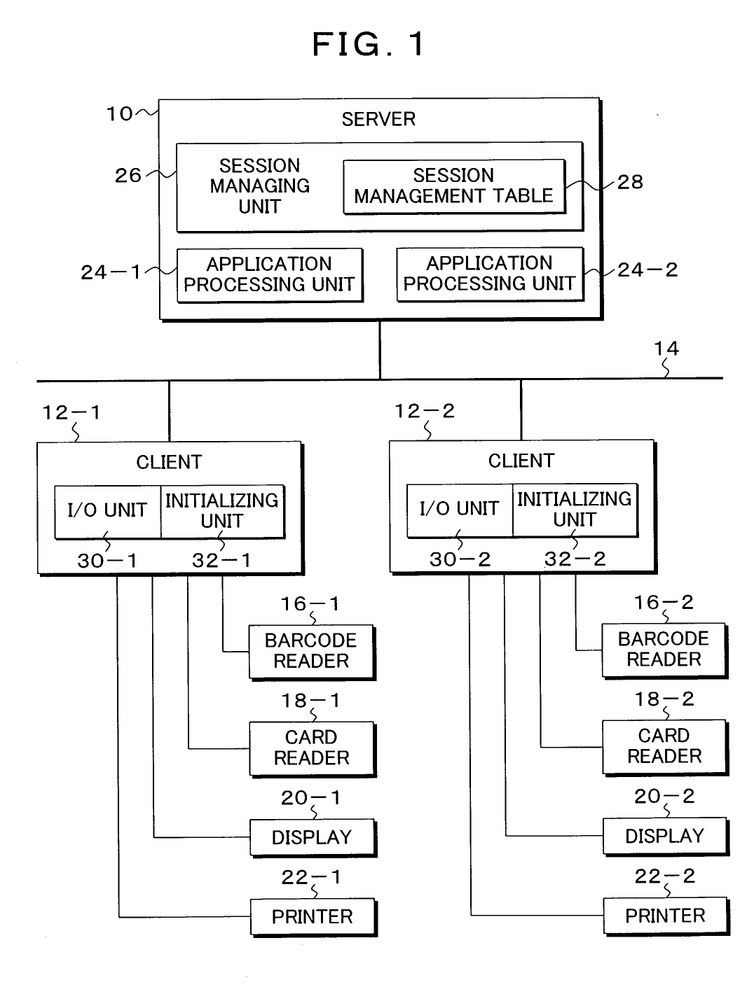

FIG. 1 is a block diagram showing a system configuration of an information processing system of the present invention, in the form of a POS system by way of example. The information processing system of the present invention comprises a server 10 to which via a communication line 14 are connected clients 12-1 and 12-2 acting as POS terminals. The clients 12-1 and 12-2 are associated with external I/O devices which include bar code readers 16-1 and 16-2, card readers 18-1 and 18-2, displays 20-1 and 20-2, and printers 22-1 and 22-2, respectively. The POS terminals provided in the form of the clients 12-1 and 12-2 can be for example TeamPos4000 and TeamPos5000 manufactured by Fujitsu Ltd. Corresponding to the external I/O devices, the clients 12-1 and 12-2 include I/O units 30-1 and 30-2, and initialization units 32-1 and 32-1 for performing the initialization processing of the I/O units. If the external I/O devices are the bar code readers 16-1 and 16-2, then the I/O units 30-1 and 30-2 are provided with drivers acting as bar code I/O units. Corresponding I/O drivers are also provided therein for the card readers 18-1 and 18-2, the displays 20-1 and 20-2 and the printers 22-1 and 22-2. Herein, the I/O units for bar code reader used for the bar code readers 16-1 and 16-2, provided in the I/O units 30-1 and 30-2 receive initialization information sent when the clients 12-1 and 12-2 make demands for connection on the server 10, and based on the initialization information from the server 10, the initialization units 32-1 and 32-2 perform initialization processing of the I/O bar code readers provided in the I/O units 30-1 and 30-2. After the completion of the initialization processing based on the initialization information from the server 10, effected by the initialization processing units 32-1 and 32-2, the I/O units 30-1 and 30-2 receive inputs from the external I/O devices including the bar code readers 16-1 and 16-2, and transmit the input information via the communication line 14 to application processing units 24-1 and 24-2 which are application programs on the server 10, and receive output information as the result of processing by the application processing units 24-1 and 24-2 to thereby e.g., display the output information on the display 20-1 or provide a print output of output information from the printers 22-1 and 22-2.

In addition to the application processing units 24-1 and 24-2 acting as the application programs run based on the input information from the clients 12-1 and 12-2, the server 10 is provided with a session management unit 26 for managing the connection between the clients 12-1 and 12-2. The session management unit 26 includes a session management table 28 having registered thereon session management information for managing the connection with the clients 12-1 and 12-2 by the session numbers.

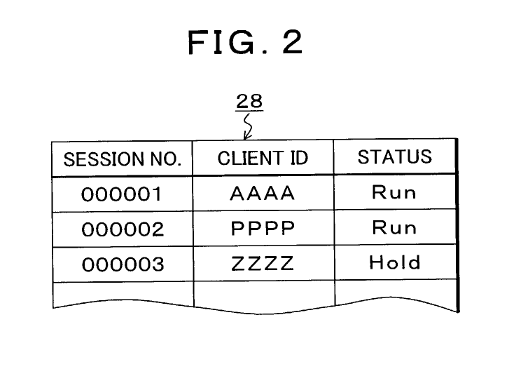

FIG. 2 is an explanatory diagram of the session management table 28 included in the session management unit 26 of FIG. 1. The session management table consists of session No., client ID, and status. The client ID for use in the session management table 28 includes account at logon of the client's POS terminal, name used at the logon, network address built up by the communication line 14, or other unique IDs. Such a client ID is included in a header of the demand for connection on the server 10 from the client, and is extracted by the server for use in the retrieval of the session management table. When receiving a demand for connection from the client 12-1 for example, the session management unit 26 extracts a client Id contained in the client's demand for connection, to retrieve the session management table 28, and if any registration conforms to the client ID of the demand for connection received on the table, acquires the session No. corresponding thereto and performs the session management for managing the connection with the client 12-1. On the contrary, if the client ID conforming thereto is not obtained even though the session management table 28 is retrieved with the client ID obtained by the demand for connection from the client 12-1, the session management unit acquires new session No. and newly enters into the session management table the thus acquired session No., the client ID and further the status which is the status of the application processing unit 20-1 at that time. Upon the new entry into the session management table 28 the session management unit 26 sends the initialization information and initializes the I/O unit for bar code reader (bar code I/O driver) for example contained in the I/O unit 30-1 of the client 12-1. If upon the connection with the client 12-1, power to the client 12-1 is shutoff and the communication failure is judged in this state by the output information sent via the communication line 14 from the application processing unit 24-1, the session management unit 26 interrupts the processing of the application processing unit 24-1. Otherwise, if output information is obtained from the application processing unit 24-1, the session management unit 26 holds this output information and enters as status into the session management table 28 “Hold” indicative of the interruption, like the session having the client ID “ZZZZ” of the session No. “000003” for example. When the power to the client 12-1, which was once shutoff, is restored in such a connection interrupted status in the server 10 and the demand for connection is received from the client 12-1, the session management unit 26 acquires the session No. through the retrieval based on the client ID of the session management table 28, and if recognition is made that the session is in interruption from the status “Hold”, the session management unit 26 sends the initialization information to the client 12-1 previous to the resumption of the processing of the application processing unit 24-1 and to the sending of the output information to the client 12-1. For this reason, the client 12-1 activated by reenergizing after power shutoff can receive initialization information as a result of a demand for connection on the server 10, and based on the reception of the initialization information the initialization processing unit 32-1 performs initialization of the I/O unit 30-1, e.g., initialization processing of the I/O unit for bar code reader to thereby enable the status of the client 12-1 at the power shutoff to again be obtained. Thus, in cases where output information is sent from the application processing unit 24-1 of the server 10 resuming its processing, the interrupted processing can continue since the initialization processing in the I/O unit 30-1 of the client 12-1 is complete. When the client 12-1 suffers the power shutoff in connection, the same operator may log on an idle client 12-2 for example to make a demand for connection on the server 10 without waiting for the restoration of power so that the interruption of session executed by the demand for connection from the client 12-1 can continue in response to the new demand for connection from the client 12-2. At that time, the session management unit 26 extracts the same client ID as the client ID of the client 12-1 currently in interruption from the demand for connection from the client 12-2 and retrieves the session management table 28 so that it can be recognized that a session having a session No. demanded for connection is currently in interruption. In this case, the session management unit 26 makes a demand for verification on the client 12-1 in interruption but has no response from the client 12-1 to the demand for verification due to its power shutoff, whereby the session management unit 26 can recognize the failure on the client 12-1 side and switch the session to the connection with the client 12-2 to thereby continue the processing. In cases where a demand for connection is received from another client 12-2, with the session corresponding to the session No. of the client 12-1 being uninterrupted, the session management unit 26 makes a demand for verification on the client 12-1 of the session No. having the same client ID and judges a failure when no verification response is obtained from the client 12-1, and switches the session by the connection with the client 12-1 to the session of the client 12-2 in response to the demand for connection from the client 12-2. Such processing allowing another client 12-2 to continue to the session with the session of the client 12-1 uninterrupted will result in measures in cases where, e.g., the POS terminal acting as the client 12-1 has inadvertently dropped and broken, leading to a stall.

The session management unit 26 provided in the server 10 of the present invention makes a periodic demand for verification on the client of the session with session No. entered in the session management table 28, and if no verification response is received, changes the status of that session management No. to “Hold” indicative of interruption. Thus, for example, if the client 12-1 has broken and resulted in a stall, the same operator will log on another client 12-2 using the same client ID and make a demand for connection on the server 10. At that time, the session management unit 26 recognizes that the session is in interruption through the retrieval of the session management table 28 based on the client ID extracted from the demand for connection. Then, the session management unit initializes the client 12-2 which has made a demand for connection, using the initialization information, immediately without making a demand for verification on the client 12-1, and thereafter can resume the processing by the application processing unit 24-1.

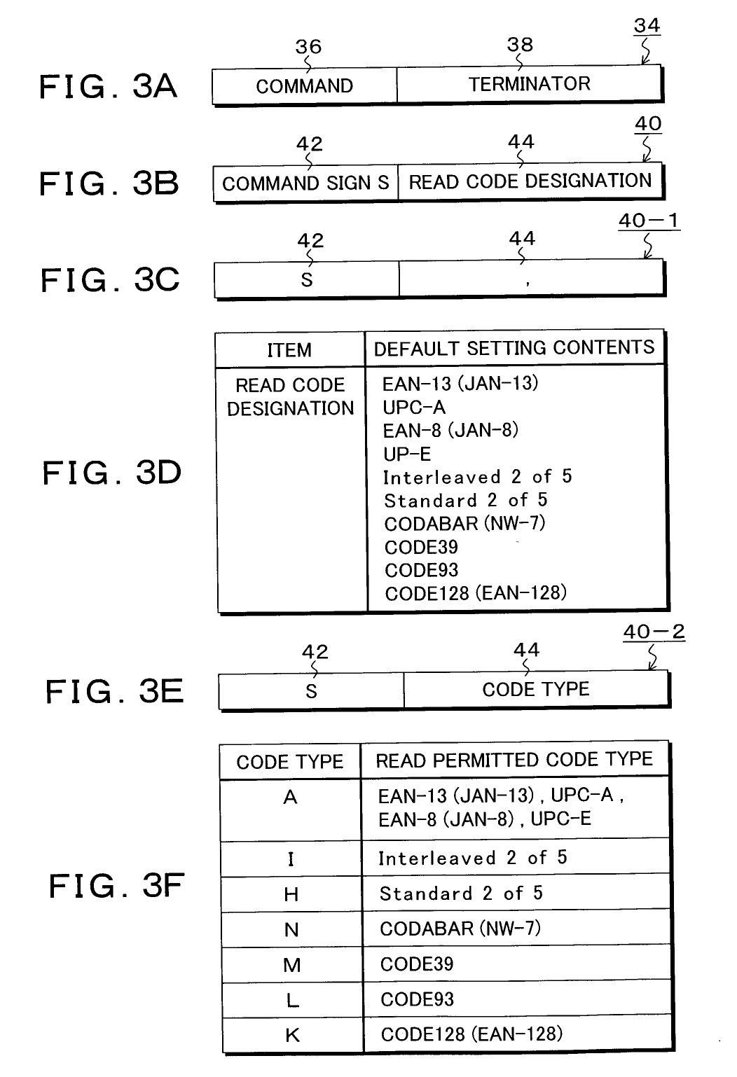

FIGS. 3A to 3F are explanatory diagrams of control commands which are initialization information sent for initialization processing of the I/O unit for bar code reader included in the I/O units 30-1 and 30-2, from the application processing units 24-1 and 24-2 of the server 10, in response to demands for connection from the clients 12-1 and 12-2 of FIG. 1. FIG. 3A shows a communication format of a control command 34 sent from the server 10 of FIG. 1 to the clients 12-1 and 12-2. The control command 34 consists of a command 36 and a terminator 38. FIG. 3B shows a bar code reader initialization command 40 for initializing the I/O unit for bar code reader provided in the I/O units 30-1 and 30-2 of the clients 12-1 and 12-2 of FIG. 1. The bar code reader initialization command 40 consists of a command sign 42 and a read designation code 44. The bar code reader initialization command 40 includes two commands, i.e., a default setting initialization command 40-1 of FIG. 3C and an option setting initialization command 40-2 of FIG. 3E.

The default setting initialization command of FIG. 3C consists of a command sign S and a read code designation “,”. It is to be noted that the default setting initialization command 40-1 can be one having in blank the command sign 42 “S” and the read designation code 44. FIG. 3D is an explanatory diagram of the read designation code and the default setting contents based on the default setting initialization commend 40-1. In case of using the initialization command 40-1 of this default setting, the I/O unit for bar code reader is set into the initialization state allowing bar codes EAN-13(JAN-13), UPC-A, . . . , CODE128 (EAN-128) of types shown as the contents of the default setting to be read. In the option setting initialization command 40-2 of FIG. 3E, “S” is set as the command sign 42, and any one of code types A, I, H, N, M, L and K shown in FIG. 3F is set as the “code type” as the read code designation 44. Setting of this code type allows a selection of the code type permitted to read. In the event of setting, e.g., the code type M by the option setting initialization command 40-2, read permission of the bar code of “CODE39” is set as the initialization processing.

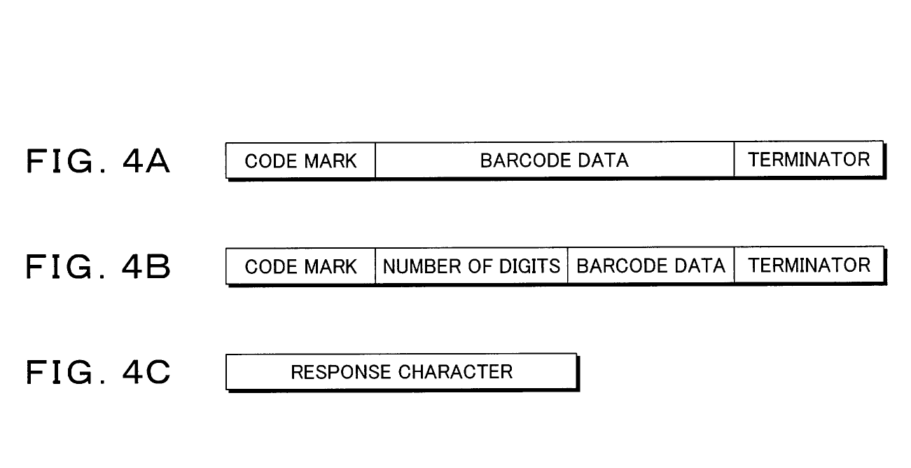

FIGS. 4A to 4C show data transfer formats for use in bar code processing between the server 10 of FIG. 1 and the clients 12-1 and 12-2, and response character communication format. FIG. 4A shows a data transfer format of the bar code reader excepting CODE94/CODE128(EAN-128) as the bar code type. On the contrary, FIG. 4B shows a data transfer format of the bar code CODE93/CODE128(EAN-128). FIG. 4C shows a format of response character which responds to a demand for verification of communication, in which predetermined characters are defined depending on the response types.

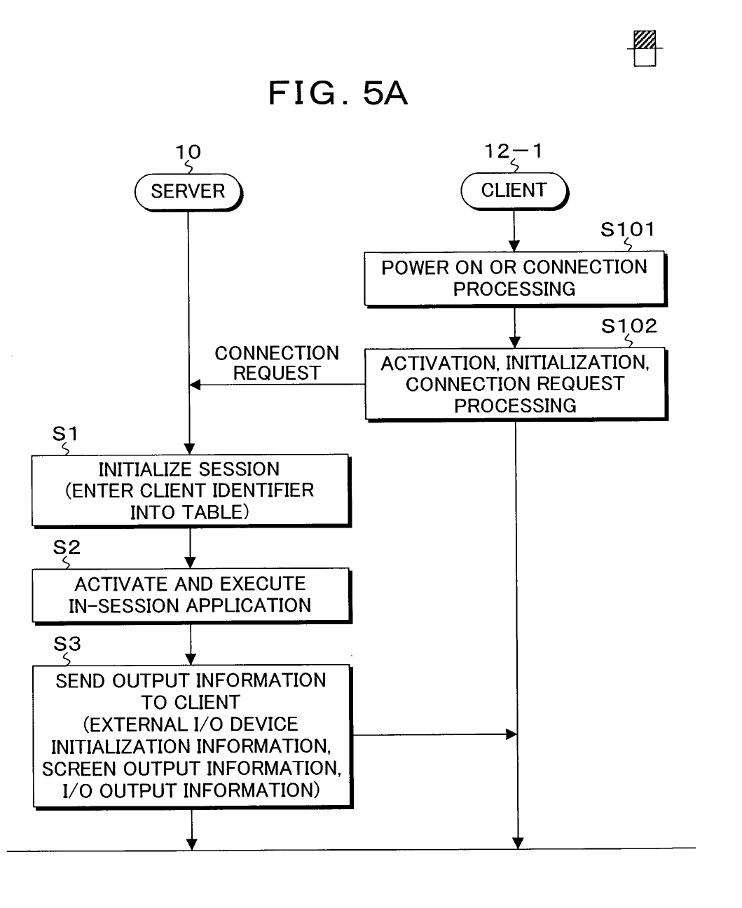

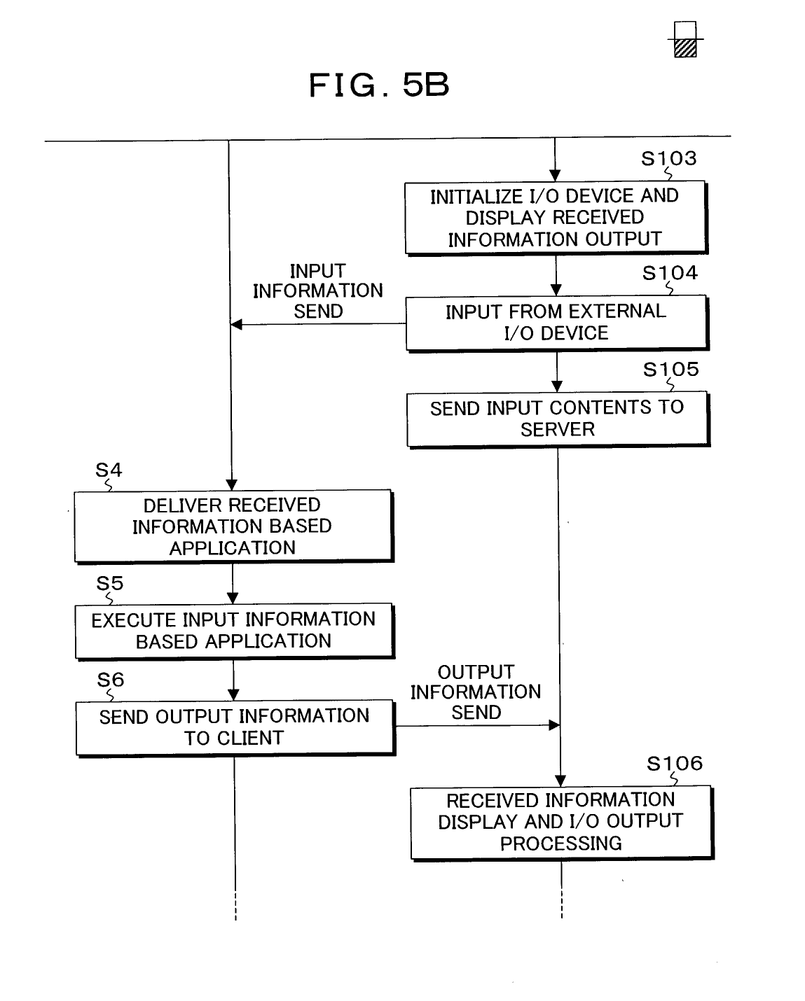

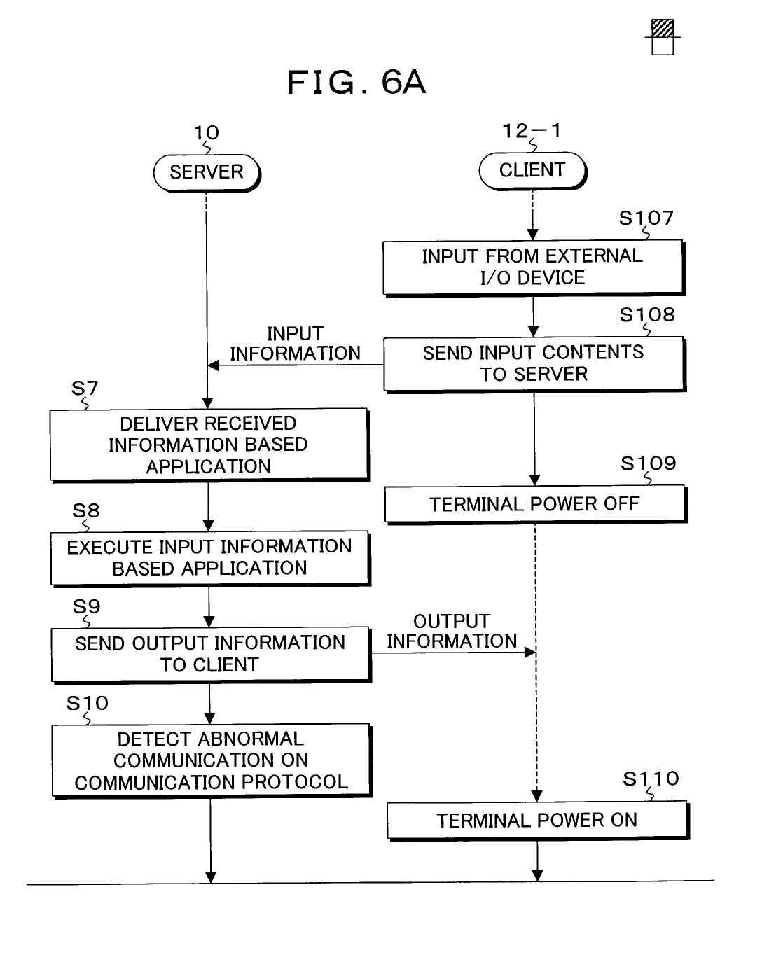

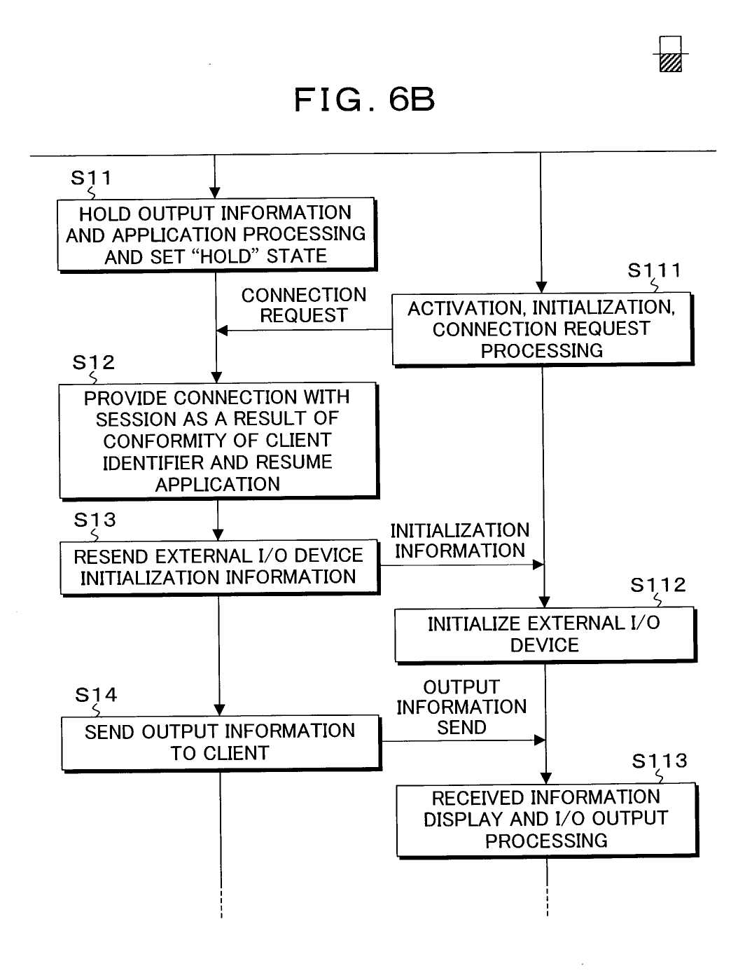

FIGS. 5A and 5B are timing charts of session initialization and session processing in connection when the client 12-1 of FIG. 1 makes a demand for connection on the server 10 and thereafter sends input information received from the external I/O device. FIGS. 6A and 6B following FIGS. 5A and 5B are timing charts of interruption and resumption when the client 12-1 suffers the terminal power shutoff and thereafter restoration of the terminal as a result of its activation.

In FIGS. 5A and 5B, the client 12-1 is turned on or performs connection processing in step S101, in response to which the activation, initialization and connection request processings are performed in step S102, to send a demand for connection to the server 10. Upon reception of the demand for request from the client 12-1, the server 10 performs the session initialization in step S1. The session initialization includes extracting a client ID such as an account for logon from the connection demand from the client 12-1, retrieving the session management table shown in FIG. 2, acquiring a new session No. on the condition that there is no same client ID, and newly entering the session No. together with the client ID and the status into the session management table 28. Then in step S2, the application within the session, i.e., the application processing unit 24-1 provided in the server 10 of FIG. 1 is activated and executed. Then in step S3, output information is sent to the client 12-1 which has made the demand for connection. This output information to the client 12-1 contains external I/O device initialization processing, screen output information and I/O output information. The external I/O device initialization information is for example the default setting initialization command 40-1 of FIG. 3C for the bar code reader driver within the I/O unit 30-1 corresponding to the bar code reader 16-1 provided in the client 12-1 of FIG. 1, or the option setting initialization command 40-2 of FIG. 3E. Upon reception of the output information sending in response to the connection demand from the server 10, if it is a driver, e.g., a bar code reader driver, within the I/O unit corresponding to the I/O device, then the client 12-1 in step S103 initially sets the readable bar code type, displays the received information on the display 20-1 to provide a sales input screen, and outputs the received information to the printer 22-1 to perform the required printing output. When receiving an input from the external I/O device in step S104 after the completion of such the session initialization, the client 12-1 sends the input information to the server 10. The server 10 in step S4 delivers the input information received from the client 12-1 to the application processing unit 24-1 as the application program, executes the application based on the input information in step 5, and sends the output information obtained as the processing result to the client 12-1 in step S6. Upon reception of the output information from the server 10, the client 12-1 performs the display of the received information and the I/O output processing. Then in step 107 of FIGS. 6A and 6B, the client 12-1 again receives an input from the external I/O device, sends the contents of input to the server 10, and delivers them to the application of the received information in step S7 and executes the application of the input information in step S8. In this state, the client 12-1 suffers the terminal power shutoff as in step S109. As a result of this terminal power shutoff, the client stops its operational functions. In the state where the client 12-1 is in stall, the server 10 sends the output information obtained as the processing result by the execution of the application to the client 12-1. However, even though the server 10 sends the output information to the client 12-1, the client 12-1 has already stopped its functions by the power shutoff, and thus in step S10 a failure is detected on the communication protocol. In response to the detection of this communication failure, the server 10 in step S11 interrupts the processing of the application processing unit 24-1 and holds the status at the interruption, and then sets “Hold” indicative of interruption as the status of the session management table 28. On the other hand, after the terminal power shutoff in step S109, the client 12-1 is restored as a result of the terminal activation in S110. Upon this restoration following the terminal activation, the client 12-1 performs the activation, initialization and connection request processing to the server 10 such that a demand for connection is sent to the server 10. When receiving the connection demand from the client 12-1 following the power recovery, the server 10 in step S12 retrieves the session management table 28 by the client ID extracted from the demand for connection, acquires the session No. having identical client ID, and resumes the processing the application processing unit 10-1. Then in step S13, the server 10 again sends the initialization information of the external I/O device to the client 12-1 which has made the demand for connection. For this reason, the client 12-1 activated as a result of powering again receives the initialization information from the server 10 to perform the initialization of the I/O unit of the external I/O device, then receives the output information from the server 10, and performs the display processing of the received information and the output processing to the printer. In the event that the client suffers a power shutoff in connection, that a failure of the client is detected from the sending of the output information from the server to interrupt the session, and that thereafter the client is again activated, then the server first sends the initialization information in response to the connection demand following the reactivation, to perform the initialization processing of the external I/O device input unit in the client, after which the server 10 resumes the application processing and the sending of the output information, thereby making it possible to continue the processing which has once been interrupted by the power shutoff in spite of a temporary power shutoff in the client 12-1.

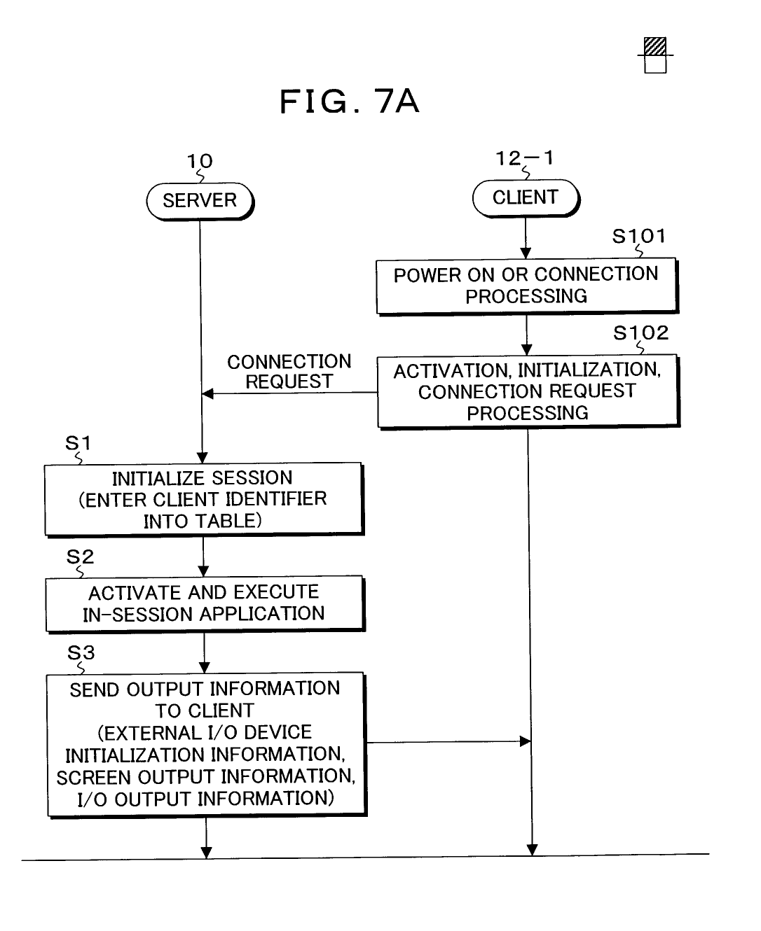

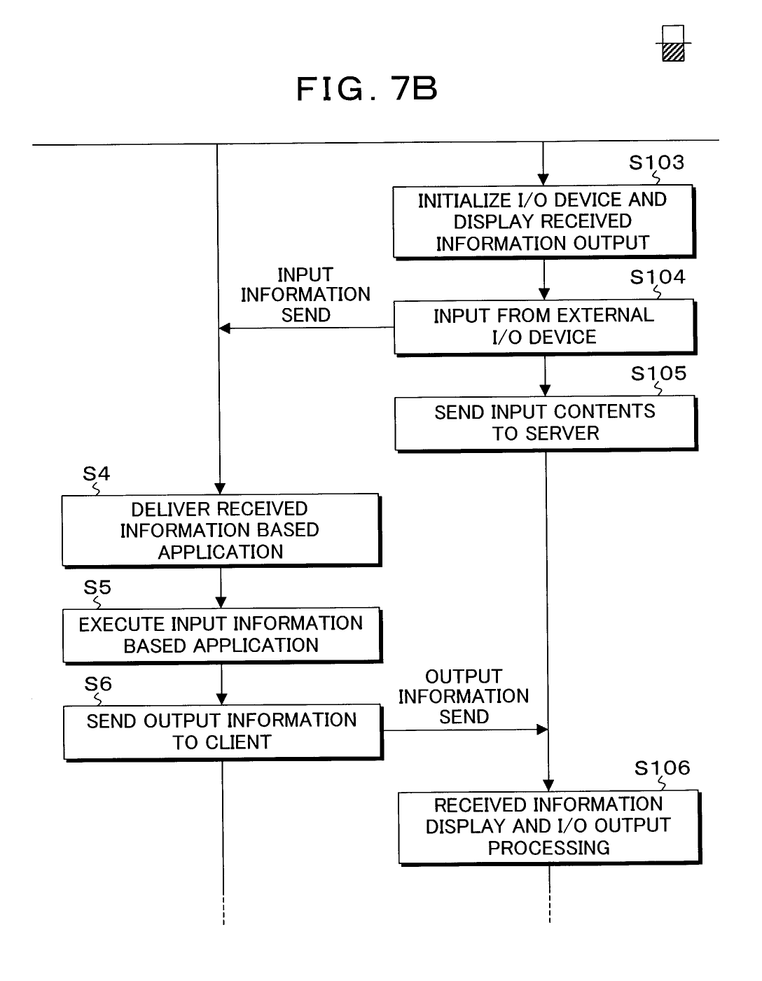

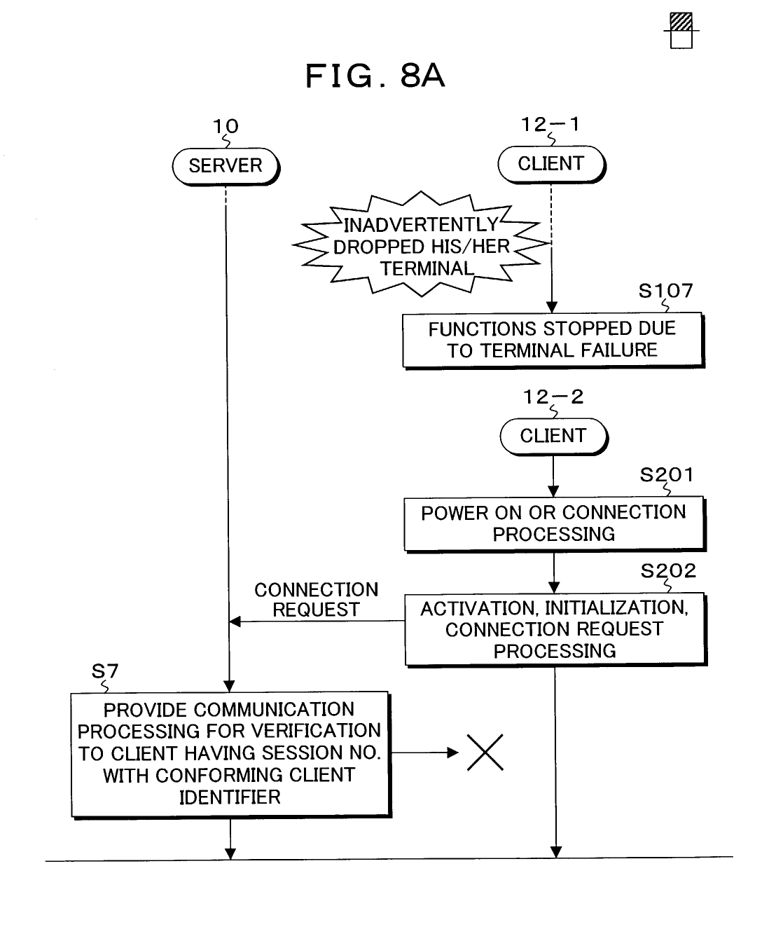

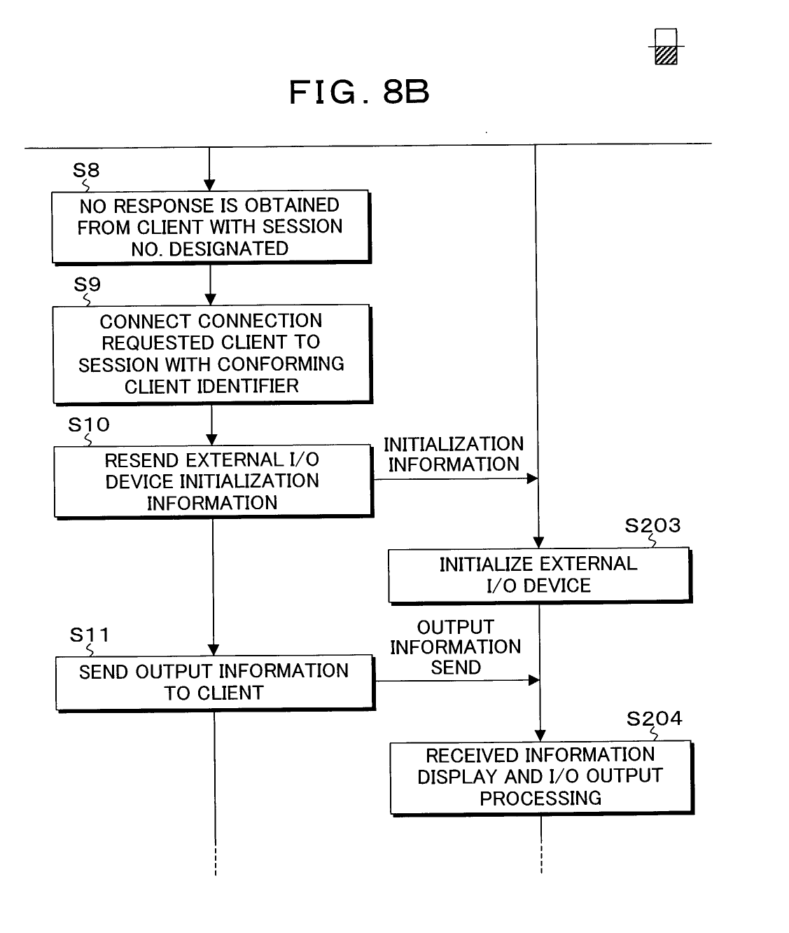

FIGS. 7A, 7B, 8A and 8B are flowcharts of processing continueing the processing by switching to another client in the absence of session interruption. FIGS. 7A and 7B are timing charts of the session initialization and the post-initialization session processing effected through the communication from the server in response to the connection demand from the client 12-1 of FIG. 1. FIGS. 8A and 8B are timing charts following FIGS. 7A and 7B in cases where the client 12-1 inadvertently dropped and broke, resulting in a stall, the client 12-1 being replaced by the client 12-2 to make a demand for connection to continue the processing. The same as in the timing charts of FIGS. 5A and 5B are the session initialization of the server 10 side following the connection demand from the client 12-1 and the execution of the application processing by sending of the input information from the client 12-1 in FIGS. 7A and 7B. Then the procedure goes to FIGS. 8A and 8B in which the client 12-1 inadvertently dropped and thereby broke resulting in a stall due to the breakage of the terminal in Step S107. Thus, the operator uses the client 12-2 in place of the broken client 12-1 and performs the power turning-on and the connection processing. Following this, the client 12-2 is activated and initialized in step S202, to send a demand for connection by the connection request processing to the server 10. When receiving a demand for connection from the other client 12-2, the server 10 in step S7 extracts as the client ID the client ID extracted from the connection demand, e.g., an account by logon of the same operator as the client 12-1, recognizes the session from the session No. of the conforming client ID through the retrieval of the session management table 28 of FIG. 2, and performs the communication processing for verification to the client 12-1 corresponding to the session in succession. At that time, however, the client 12-1 to verify has broken and resulted in a stall, and hence no response is obtained from the client 12-1 to verify and the server 10 can recognize that the client 12-1 has suffered a failure. Then in step S9, the client 12-2 demanded for connection is connected to the session of the client 12-1 whose failure has been verified, to resume the application. At the same time, in step S10, the server 10 again sends initialization information to the client 12-2 demanded for connection, in order to initialize the I/O unit of the external I/O device. Upon the reception of the initialization information from the server 10, the client 12-2 in step S203 performs the initialization processing of the I/O unit corresponding to the external I/O device. Then, the server 10 in step S10 performs the sending of the screen information attendant on the connection demand and the sending of the I/O output information, in response to which the client in step S204 performs the display of the received information and the I/O output processing, whereby the session initialization is complete of the client 12-2 which has newly been started to use, after which output processing can be carried out by the request and response of the processing to the server 10 based on the input of the I/O device. Upon such a stall due to the damage, etc., of the client in the session connection, the same operator makes a demand for connection from the other client using the same client ID, e.g., logon account, whereby the server can recognize the failure through the verification to the client having the identical client ID in session processing, and connect the session to the client which has newly made a connection demand to thereby allow the other client to continue the processing even though the client side has stopped.

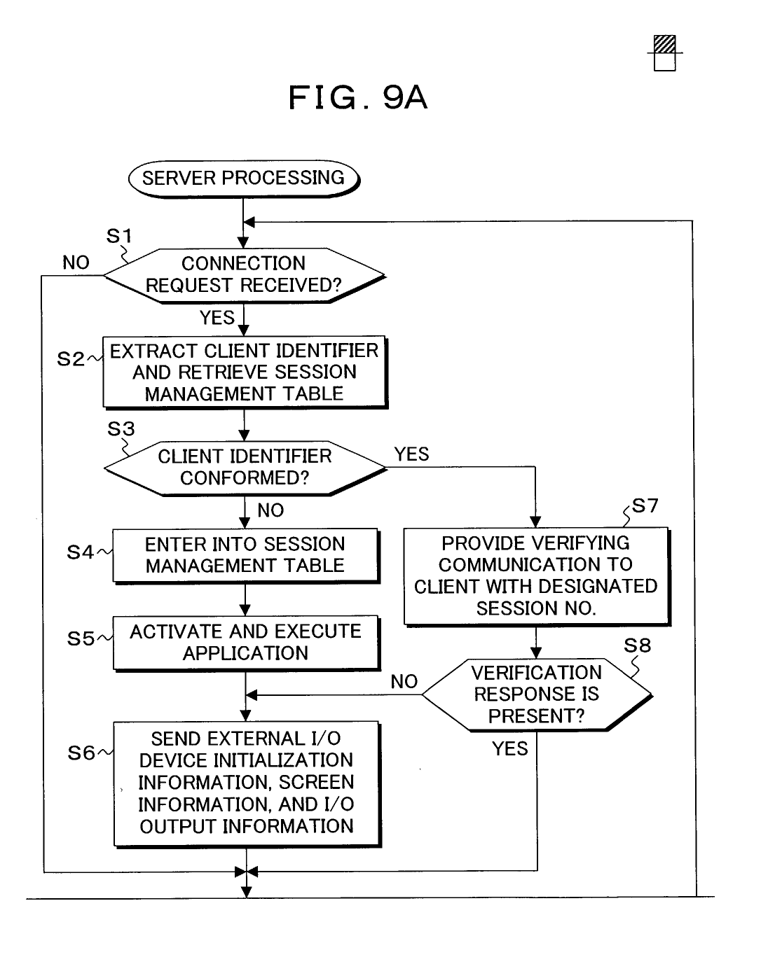

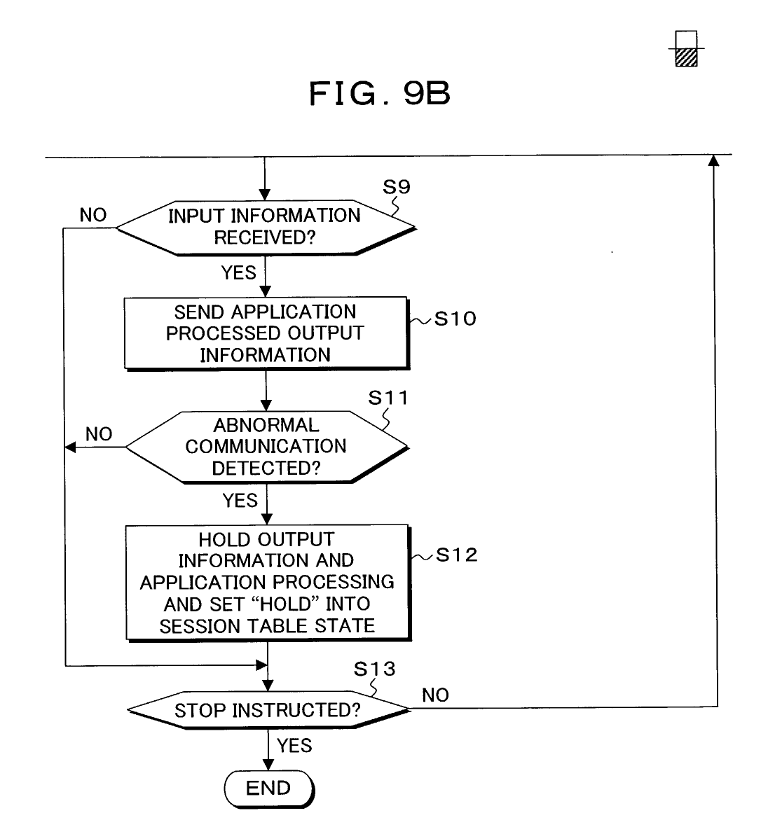

FIGS. 9A and 9B are flowcharts of server processing effected by the server 10 of the present invention. First, in step S1, a check is made of the reception of a demand for connection from the client, and if the demand for connection is present, then the procedure goes to step S2 in which the client ID is extracted to retrieve the session management table 28. If any identical client ID is absent through the retrieval of the session management table 28, then the procedure goes from step S3 to step S4 in which the session No. of the session management table 28 is acquired and registered together with the client ID and the application processing status. Then in step S5, the application is activated and executed, and in step S6 the server sends to the client the I/O device initialization information, screen information and I/O output information. Then the server makes a check in step S9 of the reception of input information based on the input of the external I/O device effected by the client following the session initialization, and if the input information is received, then in step S10 delivers the input information to the application processing unit for processing and sends the thus processed output information to the client. The server detects in step S11 whether any communication failure is present or not of the output information sent to the client, and if affirmative, then goes to step S12 to keep the output information and the status of the application at that time and set the status of the session management table to “Hold”. Naturally, if normal communication is achieved in step S11, the procedure goes to step S13 to return to step S1 till the reception of a stop instruction. In step S1, the server checks the reception of a demand for connection, and if no demand for connection is received, then waits for the reception of the next input information in step S9. In cases where any failure is detected in communication with the client in step S11 and session is interrupted in step S12, if the cause of the communication failure is a power shutoff of the client, then a new demand for connection is issued upon the restoration of power, whereas if switch of use is made to the other client as a result of the breakage of the client, then the connection demand is issued through logon by power turning-on of the other client. Thus, when the demand for connection is received from the client in this state in step S1, an identical client ID is obtained through the retrieval of the session management table of the client ID in step S2, and hence the procedure goes to step S3 to step S7. In step S7, the server performs the verification communication with the client of the designated session No. having the identical client ID. At that time, if the client makes a demand for connection as a result of power recovery, then a normal response will be obtained to the verification response, and the procedure goes to step S9 to perform processing attendant on the reception of the next input information. On the contrary, if the demand for connection is made by use of the other client in cases where the client is broken or is not restored of the power, then no verification response will be obtained in step S8, and in this case, the procedure goes to step S6 to send the external I/O device initialization information, screen information and I/O output information to the other client for the session initialization, and to step S9 to receive input information from the other client.

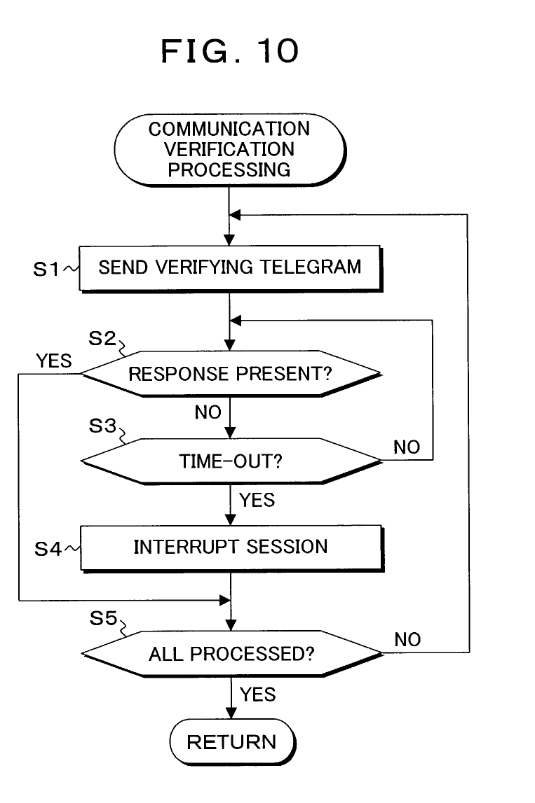

FIG. 10 is a flowchart of the communication verification processing periodically effected on the client in session connection in the server 10 of FIG. 1. This communication verification processing is carried out periodically at predetermined time cycles. First, in step S1, the server selects a client corresponding to e.g., the leading session No. of the session management table 28 of FIG. 2 and sends a verification telegram to the selected client. The server waits for a response from the client in step S2, and if no response is obtained, checks the timeout of certain time in step S3, and if the timeout is not reached, repeats the waiting processing of step S2. If no response is obtained at the timeout of step S3, then the server goes to step S4 to recognize the communication failure to judge the session interruption and enter “Hold” into the status of the session management table. Then in step S5, the server checks to see if all the session Nos. of the session management table have been processed, and if negative, then goes back to step S1 to repeat the processing of verification on the client of the next session No. If the server completes the verification processing on clients of all the session Nos. currently entered in the session management table 28, then the server brings the processing to an end.

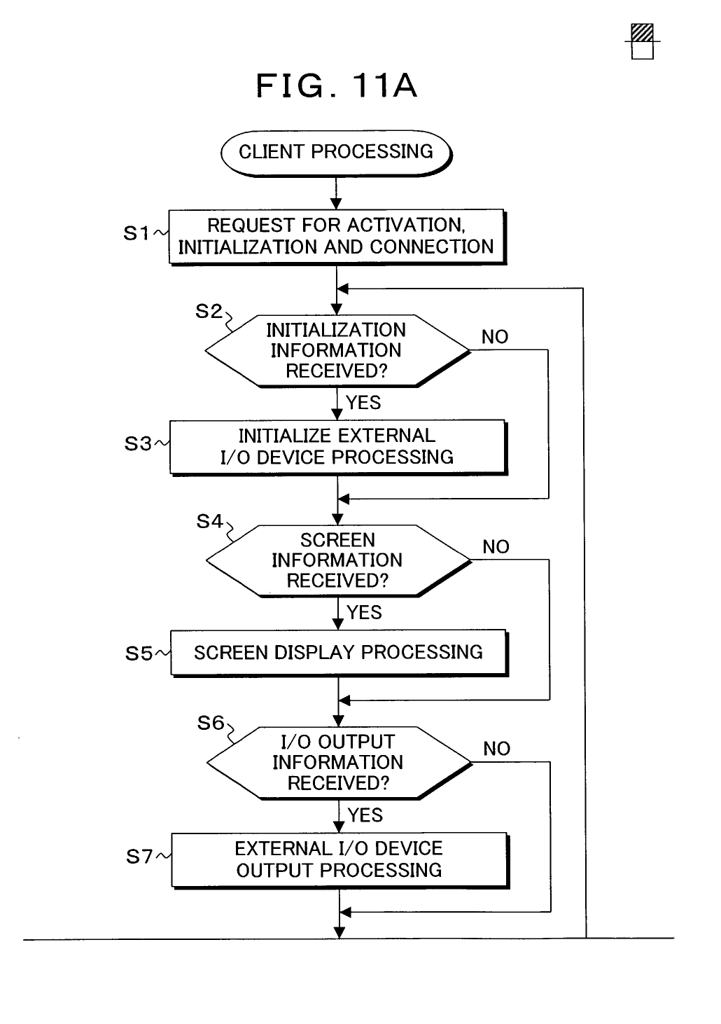

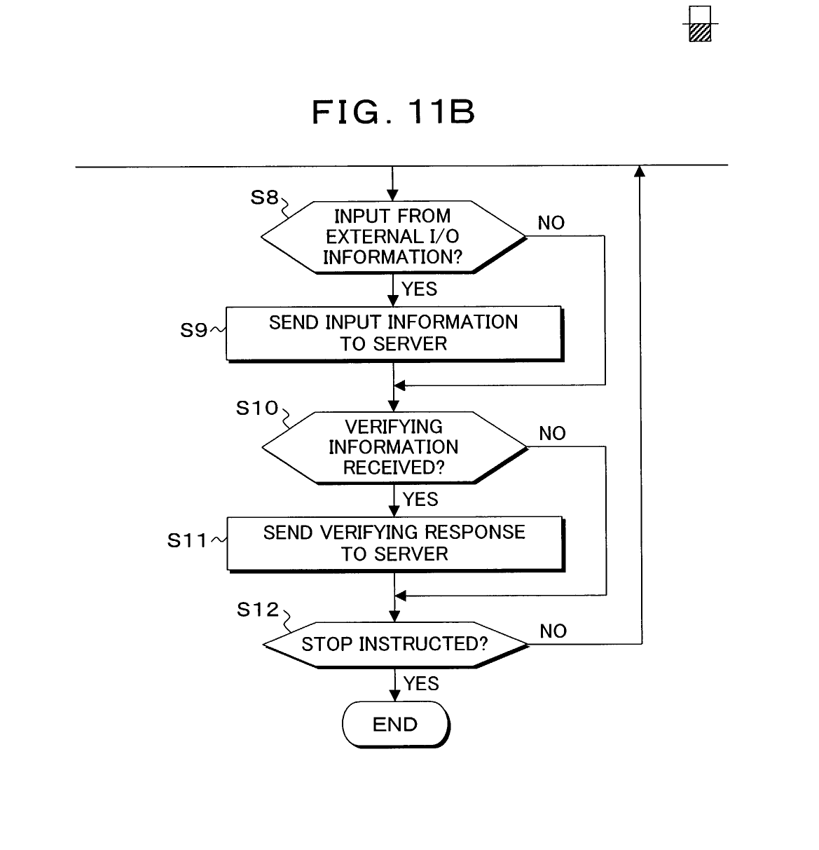

FIG. 11 is a flowchart of the client processing of the clients 12-1 and 12-2 of FIG. 1. In this client processing, the client is activated by logon attendant on the power turning-on, performs the initialization processing and thereafter makes a request to the server for connection in step S1. The client waits for the reception of the initialization information from the server in response to the request for connection in step S2, and if the initialization information is received, then performs the initialization processing on the I/O unit of the external I/O device in step S3. Then in step S4, the client waits for the reception of the screen information from the server, and if the screen information is received, performs the processing to provide the screen information on the display in step S5. Then in step S6, the client waits for the reception of the I/O output information from the server, and if the I/O output information is received, then performs the output processing for the external I/O device, e.g., the printer in step S7. When through the processings of steps S1 to S7, the associated processings are complete of the session initialization attendant on the demand for connection, the client waits for the input from the external I/O device. If an input from the external I/O device is received, then in step S9 the client sends the input information to the server. In consequence, the application is executed in the server, and if screen information is sent as processing result, then the client performs the processings in steps S4 and S5, whereas if I/O information is sent, the client performs the processings in steps S6 and S7. Then in step S10, the client checks the reception of verification information from the server, and if the verification information is received, then the client sends a verification response to the server in step S11. The above processings of steps S1 to S11 are repeated till the reception of a stop instruction by logoff in step S12.

Although the above embodiment is directed to the case where the POS terminal of the POS system as the client makes a demand for connection on the server, with the server sending initialization information for setting the code type to the I/O unit for bar code reader to perform the initialization by way of example, the present invention is not limited thereto, but is applicable to any proper server-client system as long as the client is one including the I/O unit which needs the initialization on the client side, with the server sending the initialization information in response to the demand for connection from the client. The present invention includes any proper variants without impairing its objects and advantages. The present invention is not restricted by numerical values indicated in the above embodiment.

### INDUSTRIAL APPLICABILITY

According to the present invention as set forth hereinabove, it becomes possible for even the client having the I/O unit which needs initialization processing based on initialization information from the server to receive the initialization information for initialization processing prior to the resumption of the session of the server when the client side suffers a power shutoff and ceases the session after which the power is restored to again make a demand for connection, and to thereby return to the pre-power-shutoff state to securely continue the temporarily interrupted processing with the server.

In the event of being incapable of waiting for the power recovery of the client which has suffered the power shutoff, another client is used to make a demand for connection based on the identical session No., whereby the server side can recognize the switching of the client and send the initialization information based on the identical session No. to the client which has made a new demand for connection, to continuously process the session through the switching to the another client.

Even in the event that the client has broken and resulted in a stall in session connection and that a normal client has been used to make a demand for connection by the identical session No., the verification communication on the server side enables a failure of the client which has hitherto perform the session to be recognized, whereby the server can send the initialization information to the client which has newly made a demand for connection to thereby continue the session.

1. An information processing system in which a server and a client are connected to each other by way of a communication line, said client making a request to said server for processing, said client receiving the result of said processing from said server;
said client comprising:
an I/O processing unit which sends input information of an external device to said server to make a demand for processing, said I/O processing unit receiving output information from said server to output to said external device; and
an initialization unit which initializes said I/O unit based on initialization information received from said server;
said server comprising:
an application processing unit which sends initialization information of said external device upon reception of a demand for connection from said client, said application processing unit, in connection, processing input information received from said client and sending output information to said client; and
a session processing unit which manages connection with said client, said session processing unit when communication with said client ceases on said server, interrupting processing of said application processing unit to hold the status at interruption and said output information to said client, said session processing unit when communication with said client resumes, resending said initialization information to said client for initialization and resuming the processing of said application processing unit and the sending of said output information.

2. The system according to claim 1, wherein
said session management unit manages connection between said server and said client by session No., said session management unit after ceasing of communication with said client, resuming the communication when said session management unit receives a demand for connection from said client with the identical session No.

3. The system according to claim 2, wherein
said session management unit when receiving a demand for connection from another client after ceasing of communication with said client, resends initialization information to said another client and resumes the processing of said application processing unit and the sending of said output information, if the identity of said session No. is judged.

4. The system according to claim 3, wherein
said session management unit upon reception of a demand for connection from said client refers to session management information and, if there is no session No. with identical client ID, acquires a new session No. and enters it together with client ID and the status of said application processing unit into said session management information for processing, said session management unit if said client ID is identical, acquiring a session No. with said identical client ID for processing.

5. The system according to claim 4, wherein
said client ID is an account for use in login of said client, a name for use in logon, a network address or other unique identifiers.

6. The system according to claim 1, wherein
said session management unit verifies connection at certain time intervals in order to detect ceasing of communication with said client.

7. An information processing system in which a server and a client are connected to each other by way of a communication line, said client making a request to said server for processing and receiving the result of said processing from said server;
said client comprising:
an I/O processing unit which sends input information of an external device to said server to make a demand for processing, said I/O processing unit receiving output information from said server to output to said external device; and
an initialization unit which initializes said I/O unit based on initialization information received from said server;
said server comprising:
an application processing unit which sends initialization information of said external device upon reception of a demand for connection from said client, said application processing unit, in connection, processing input information received from said client and sending output information to said client; and
a session processing unit which manages connection with said client by session No., said session processing unit in connection with said client when receiving a connection demand with the identical session No. from another client, connecting to said another client which has sent said connection demand to continue the processing, if cutoff of connection is judged through the verification of connection with said client in connection.

8. The system according to claim 7, wherein
said session management unit sends initialization information of an external device to said another client which has sent said connection demand, to thereby continue the processing.

9. The system according to claim 7, wherein
said session management unit upon reception of a demand for connection from said client refers to session management information and, if there is no session No. with identical client ID, acquires a new session No. and enters it together with client ID and the status of said application processing unit into said session management information for processing, said session management unit if said client ID is identical, acquiring a session No. with said identical client ID for processing.

10. An information processing method in which a server and a client are connected to each other by way of a communication line, said client making a request to said server for processing, said client receiving the result of said processing from said server; said method comprising the steps of:
when said server receives a demand for connection from said client, sending initialization information from said server to said client to initialize an external device I/O unit;
when said server and said client are in connection, processing input information of an external device received from said client, by an application program on said server, and sending output information to said client for output;
managing connection with said client on said server, and if communication with said client ceases on said server, interrupting said application program to hold the status at interruption and said output information to said client; and
at the time when communication with said client resumes, resending said initialization information to said client for initialization, and resuming the processing of said application program and the sending of said output information.

11. The method according to claim 10, wherein
connection between said server and said client is managed by session No., and wherein
after ceasing of communication with said client, said communication is resumed when receiving a demand for connection from said client with the identical session No.

12. The method according to claim 11, wherein
when receiving a demand for connection from another client after ceasing of communication with said client, resending initialization information to said another client with identical session No. and resuming the processing of said application processing unit and the sending of said output information.

13. The method according to claim 12, wherein
upon reception of a demand for connection from said client, referring to session management information and, if there is no session No. with identical client ID, acquiring a new session No. and entering it together with client ID and the status of said application processing unit into said session management information for processing, if said client ID is identical, acquiring a session No. with said identical client ID for processing.

14. The method according to claim 13, wherein
said client ID is an account for use in login of said client, a name for use in logon, a network address or other unique identifiers.

15. The method according to claim 10, further comprising the step of:
verifying connection at certain time intervals in order to detect ceasing of communication with said client.

16. An information processing method in which a server and a client are connected to each other by way of a communication line, said client making a request to said server for processing, said client receiving the result of said processing from said server; said method comprising the steps of:
when said server receives a demand for connection from said client, sending initialization information from said server to said client to initialize an external device I/O unit;
when said server and said client are in connection, processing input information of an external device received from said client, by an application program on said server, and sending output information to said client for output;
managing connection with said client by session No. on said server, and when receiving a connection demand with the identical session No. from another client while being in connection with said client, connecting to said another client which has sent said connection demand to continue the processing, if cutoff of connection is judged through the verification of connection with said client in connection.

17. The method according to claim 16, wherein
sending initialization information of an external device to said another client which has sent said connection demand, to thereby continue the processing.

18. The method according to claim 16, wherein
upon reception of a demand for connection from said client, referring to session management information and, if there is no session No. with identical client ID, acquiring a new session No. and entering it together with client ID and the status of said application processing unit into said session management information for processing, and if said client ID is identical, acquiring a session No. with said identical client ID for processing.

19. A server connected via a communication line to a client, said server comprising:
an application processing unit which sends initialization information of an external device I/O unit upon reception of a demand for connection from said client, said application processing unit, in connection, processing input information received from said client and sending output information to said client; and
a session processing unit which manages connection with said client by session No., said session processing unit when communication with said client ceases on said server, interrupting processing of said application processing unit to hold the status at interruption and said output information to said client, said session processing unit when communication with said client resumes as a result of a demand for connection with the identical session No., resending said initialization information to said client for initialization and resuming the processing of said application processing unit and the sending of said output information.

20. A server connected via a communication line to a client, said server comprising:
an application processing unit which sends initialization information of an external device I/O unit upon reception of a demand for connection from said client, said application processing unit, in connection, processing input information received from said client and sending output information to said client; and
a session processing unit which manages connection with said client by session No., said session processing unit in connection with said client when receiving a connection demand with the identical session No. from another client, connecting to said another client which has sent said connection demand to continue the processing, if disconnection is judged through the verification of connection with said client in connection.
